(19) United States
(12) Patent Application Publication
(10) Pub. No.: US 2014/0351776 A1
(43) Pub. Date: Nov. 27, 2014

(54) DETECTING DEVICE AND METHOD FOR PCB LAYOUT

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: GUANG-FENG OU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/138,437

(22) Filed: Dec. 23, 2013

(30) Foreign Application Priority Data
May 22, 2013 (CN) 2013101908175

(51) Int. Cl. G06F 17/50

(52) U.S. Cl. CPC G06F 17/5081
USPC 716/111

(57) ABSTRACT

A detecting device includes an input device, a display, and a computer system. The computer system includes a setting module, a storing module, a detecting module, and a control module. The storing module stores a PCB layout file. The setting module receives detecting parameters inputted by the input device. The detecting module detects the PCB layout file according to the detecting parameters to obtain detecting data corresponding to the detecting parameters. The control module displays a “fail” message on the display if the detecting data does not match standard data.

### BACKGROUND

1. Technical Field

The present disclosure generally relates to a detecting device and method for a layout of a printed circuit board (PCB).

2. Description of Related Art

Circuit boards, such as printed circuit boards (PCBs), are widely used in electronic devices. The PCBs are manufactured according to a layout design. The layout design is first created on a computer, and then a layout file is stored in the computer. However, the layout file may have some layout problems, which need to be amended manually.

### BRIEF DESCRIPTION OF THE DRAWINGS

Many aspects of the embodiments can be better understood with parameters to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of one embodiment of a detecting device.

FIG. 2 is a flowchart of one embodiment of a PCB layout detecting method.

### DETAILED DESCRIPTION

The disclosure is illustrated by way of example and not by way of limitation in the figures of the accompanying drawings in which like parameters indicate similar elements. It should be noted that parameters to “an” or “one” embodiment in this disclosure are not necessarily to the same embodiment, and such parameters mean “at least one.”

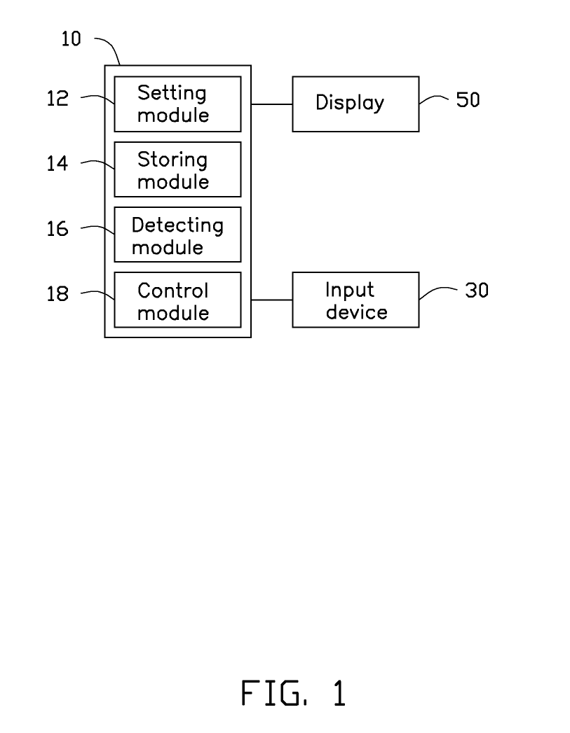

FIG. 1 shows a detecting device including a computer system 10, an input device 30, and a display 50. The computer system 10 is connected to the input device 30 and the display 50. In one embodiment, the input device 30 includes a keyboard and a mouse. The computer system 10 includes a setting module 12, a storing module 14, a detecting module 16, and a control module 18. The storing module 14 stores a layout file for a printed circuit board, as well as standard data corresponding to parameters of the printed circuit board. The layout file includes a plurality of symbols for components, such as power pins, vias, capacitors, and the like.

The setting module 12 is configured to receive detecting parameters inputted through the input device 30. The detecting module 16 is configured to detect the layout file according to the detecting parameters to obtain detecting data corresponding to the detecting parameters.

The control module 18 is configured to determine whether the detecting data matches the standard data. If the detecting data matches the standard data, the control module 18 displays a “pass” message on the display 50. If the detecting data does not match the standard data, the control module 18 displays a “fail” message on the display 50. The fail data includes names of the components' symbols, positions of the components' symbols, and difference values between the detecting data and the standard data.

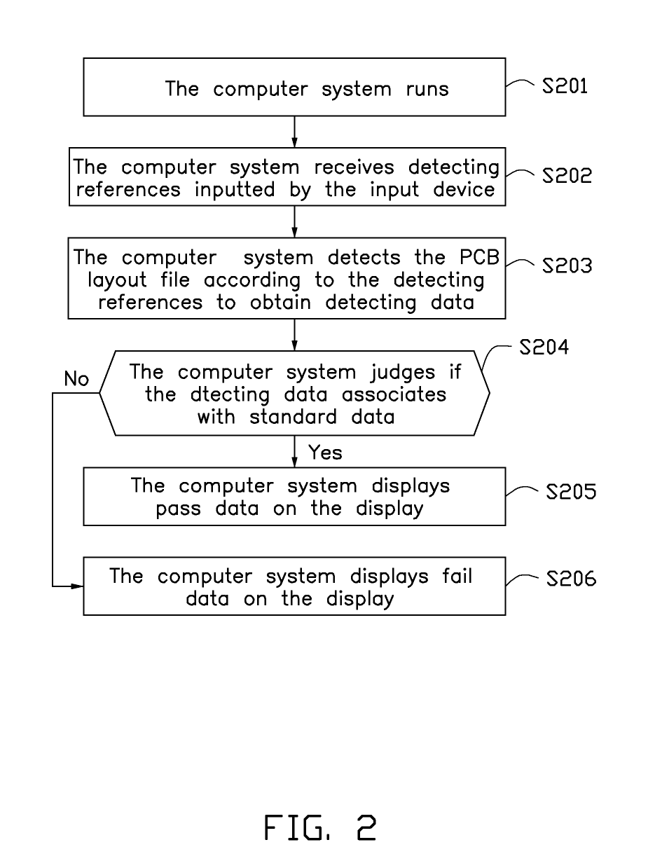

FIG. 2 shows that a PCB layout file detecting method includes the following steps.

In step S201, the computer system 10 is turned on.

In step S202, the setting module 12 receives the detecting parameters inputted by the input device 30.

In step S203, the detecting module 16 detects the layout file according to the detecting parameters to obtain the detecting data corresponding to the detecting parameters.

In step S204, the control module 18 determines if the detecting data matches the standard data; if so, step S205 is implemented; if not, step S206 is implemented.

In step S205, the control module 18 displays a “pass” message on the display 50.

In step S206, the control module 18 displays a “fail” message on the display 50. The “fail” message includes the names of the components' symbols, the positions of the components' symbols, and difference values between the detecting data and the standard data.

It is to be understood, however, that even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A detecting device comprising:
an input device;
a display; and
a computer system, the computer system comprises a setting module, a storing module, a detecting module, and a control module; the storing module is configured to store a PCB layout file; the setting module is configured to receive detecting parameters inputted by the input device; the detecting module is configured to detect the PCB layout file according to the detecting parameters to obtain detecting data corresponding to the detecting parameters; and the control module is configured to display fail data on the display after determining that the detecting data does not match standard data.

2. The detecting device of claim 1, wherein the PCB layout file comprises a plurality of component symbols; and the fail data comprises name of some of the plurality of component symbols, positions of the some of the plurality of component symbols, and difference value between the detecting data and the standard data.

3. The detecting device of claim 1, wherein the control module is configured to display pass data on the display after determining that the detecting data matches the standard data.

4. A PCB layout detecting method, comprising:
providing a detecting device, the detecting device comprises a computer system, an input device, and a display;
storing a PCB layout file and standard data by the computer system;
receiving, by the computer system, detecting parameters inputted by the input device;
detecting, by the computer system, the PCB layout file according to the detecting parameters to obtain detecting data corresponding to the detecting parameters; and
displaying, by the computer system, fail data on the display after determining that the detecting data does not match the standard data.

5. The PCB layout detecting method of claim 4, further the PCB layout file comprises a plurality of component symbols; and the fail data comprises name of some of the plurality of component symbols, positions of the some of the plurality of component symbols, and difference value between the detecting data and the standard data.

6. The PCB layout detecting method of claim 4, further comprising displaying pass data on the display after determining that the detecting data matches the standard data.
